(19) United States
(12) Patent Application Publication
(10) Pub. No.: US 2005/0230882 A1
(43) Pub. Date: Oct. 20, 2005

(54) Method of forming a deep-featured template employed in imprint lithography

(75) Inventors: Michael P.C. Watts, Austin, TX (US); Nicholas A. Stacey, Austin, TX (US); Michael N. Miller, Austin, TX (US)

Correspondence Address: MOLECULAR IMPRINTS, INC.;KENNETH C. BROOKS, PO BOX 81536, AUSTIN, TX, 78708-1536, US

(73) Assignee: Molecular Imprints, Inc., Austin, TX (US)

(21) Appl. No.: 10/827,118

(22) Filed: Apr. 19, 2004

(51) Int. Cl. B29C 35/08

(52) U.S. Cl. 264/496

(57) ABSTRACT

The present invention is directed to a method of forming a pattern on a plate employing a mold. The method includes placing the plate in superimposition with said mold. Formable material is positioned between that plate and the mold. A pattern is formed in the formable material having a shape complementary to the shape of the mold, defining patterned material. The patterned material is then adhered to the plate.

### BACKGROUND OF THE INVENTION

The field of invention relates generally to imprint lithography. More particularly, the present invention is directed to a method of forming a template to be used in imprint lithography processes.

Micro-fabrication involves the fabrication of very small structures, e.g., having features on the order of micro-meters or smaller. One area in which micro-fabrication has had a sizeable impact is in the processing of integrated circuits. As the semiconductor processing industry continues to strive for higher production yields while increasing the circuits per unit area formed on a substrate, micro-fabrication becomes increasingly important. Micro-fabrication provides greater process control, while allowing increased reduction of the minimum feature dimension of the structures formed. Other areas of development in which micro-fabrication have been employed include biotechnology, optical technology, mechanical systems and the like.

An exemplary micro-fabrication technique is shown in U.S. Pat. No. 6,334,960 to Willson et al. Willson et al. disclose a method of forming a relief image in a structure. The method includes providing a substrate having a transfer layer. The transfer layer is covered with a polymerizable fluid composition. A template makes mechanical contact with the polymerizable fluid. The template includes a relief structure formed from lands and grooves. The polymerizable fluid composition fills the relief structure with the thickness of the polymerizable fluid in superimposition with the lands defining a residual thickness. The polymerizable fluid composition is then subjected to conditions to solidify and to polymerize the same, forming a solidified polymeric material on the transfer layer that contains a relief structure complimentary to that of the template. The template is then separated from the solid polymeric material such that a replica of the relief structure of the template is formed in the solidified polymeric material. The transfer layer and the solidified polymeric material are subjected to an environment to selectively etch the transfer layer relative to the solidified polymeric material such that a relief image is formed in the transfer layer. Thereafter, conventional etching processes may be employed to transfer the pattern of the relief structure into the substrate.

The templates employed in the micro-fabrication described above are typically comprised of fused silica, and as a result, the templates are transparent to actinic radiation employed in the polymerization step of the polymerizable fluid composition described above. However, while fused silica templates can be readily prepared with etch depths of a few hundred nanometers, etching deep structures of the order of a few microns while maintaining vertical sidewalls is much more difficult, and obtaining etch depths on the order of tens of microns is extremely difficult. Using templates of this kind, with deep etched features are very useful when, instead of using solidified materials, as described above, as etch resists, the materials defined are intended to form part of the final device functionality. Examples where such deep etched templates are valuable include, without limitation, the formation of polymeric waveguides, the generation of micro/nano-fluidic channels, or in areas of IC packaging.

Previous art attempts have employed etching as a means for improving the feature depth of fused silica templates. However, such etching techniques have drawbacks associated therewith. Dry etching of fused silica templates to achieve etch depths of greater than a few microns, e.g. 5 μm, is problematic, and more specifically, achieving vertical sidewalls on features more than a few microns, e.g. 5 μm, in fused silica templates is difficult. Wet etching is capable of creating deep features in fused silica; however, it is not anisotropic enough to be used in this application.

It is desired, therefore, to provide an improved method of forming a template having deep features formed therein.

### SUMMARY OF THE INVENTION

The present invention is directed to a method of forming a pattern on a plate by employing a mold. The method includes placing the plate in superimposition with the mold. Formable material is present between the plate and the mold. A pattern is formed in the formable material having a shape complementary to the shape of the mold, defining patterned material. The patterned material is then adhered to the plate. These and other embodiments are described more fully below.

### BRIEF DESCRIPTION OF THE DRAWINGS

FIG. 1 is a perspective view of a lithographic system in accordance with the present invention;

FIG. 2 is a side view of the backing plate disposed opposite a mold with a pattern of the mold forming a pattern to be transferred to the backing plate;

FIG. 3 is an exploded view of FIG. 2 depicting a feature depth of the mold;

FIG. 4 is a side view of the backing plate disposed opposite the mold with an imprinting layer disposed upon the mold;

FIG. 5 is a side view of the backing plate in contact with the imprinting layer with a radiation source impinging actinic radiation upon the imprinting layer;

FIG. 6 is a side view of the backing plate having the imprinting layer disposed thereon and spaced-apart from the mold with a radiation source impinging actinic radiation upon the imprinting layer;

FIG. 7 is a side view of a template comprising the imprinting layer coupled to the backing plate formed utilizing the method employed in the present invention; and

FIG. 8 is an exploded view of FIG. 7 depicting a feature depth of the imprinting layer.

### DETAILED DESCRIPTION OF THE INVENTION

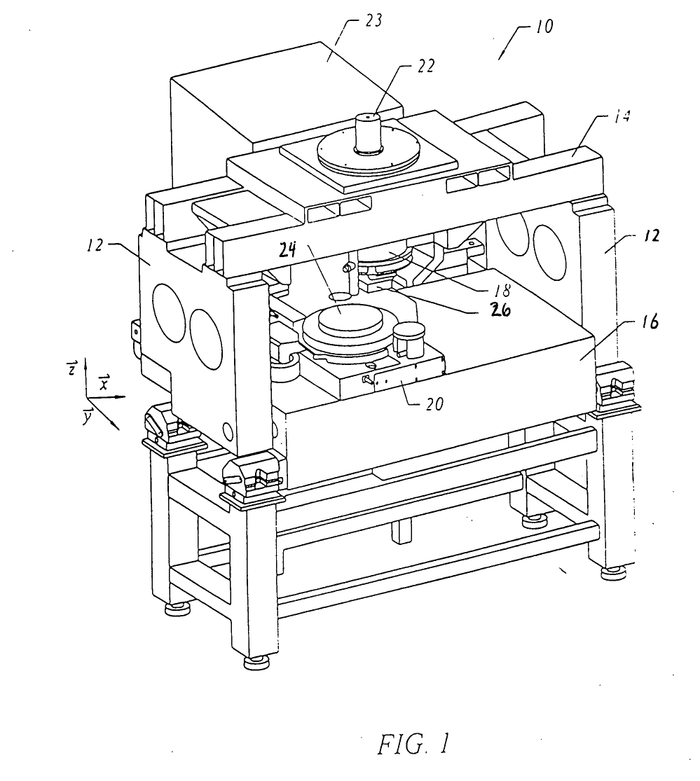

FIG. 1 depicts a lithographic system 10 that includes a pair of spaced-apart bridge supports 12 having a bridge 14 and a stage support 16 extending therebetween. Bridge 14 and stage support 16 are spaced-apart. Coupled to bridge 14 is an imprint head 18, which extends from bridge 14 toward stage support 16 and provides movement along the Z-axis. Disposed upon stage support 16 to face imprint head 18 is a motion stage 20. Motion stage 20 is configured to move with respect to stage support 16 along X- and Y-axes. It should be understood that imprint head 18 may provide movement along the X- and Y-axes, as well as the Z-axis, and motion stage 20 may provide movement in the Z-axis, as well as the X- and Y-axes. An exemplary motion stage device is disclosed in U.S. patent application Ser. No. 10/194,414, filed Jul. 11, 2002, entitled “Step and Repeat Imprint Lithography Systems,” assigned to the assignee of the present invention, and which is incorporated by reference herein in its entirety. A radiation source 22 is coupled to lithographic system 10 to impinge actinic radiation upon motion stage 20. As shown, radiation source 22 is coupled to bridge 14 and includes a power generator 23 connected to radiation source 22. An exemplary lithographic system is available under the trade name IMPRIO 100™ from Molecular Imprints, Inc., having a place of business at 1807-C Braker Lane, Suite 100, Austin, Tex. 78758. The system description for the IMPRIO 100™ is available at www.molecularimprints.com and is incorporated herein by reference.

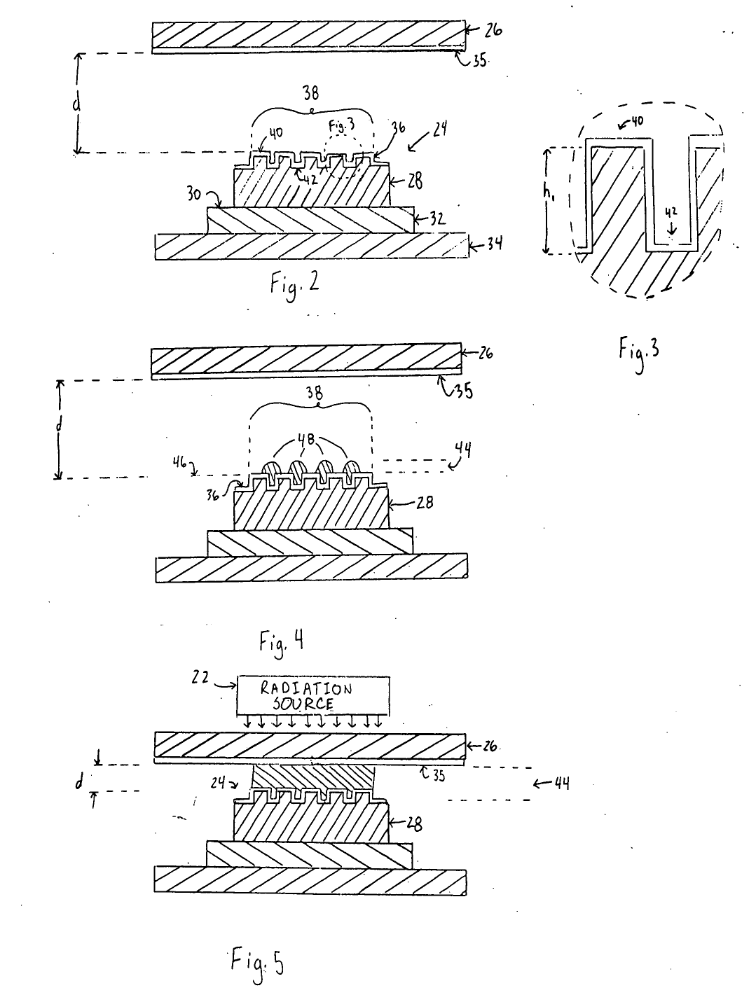

FIG. 2 shows a master template 24 spaced apart from a backing plate 26 with a distance “d” defined therebetween, with backing plate 26 being substantially parallel to master template 24. Master template 24 comprises a mold 28 disposed on a surface 30 of a substrate 32 with surface 30 having a substantially planar surface and mold 28 being substantially parallel to substrate 32. Substrate 32 is located on a wafer chuck 34 with an exemplary chuck disclosed in U.S. patent application Ser. No. 10/293,224, filed Nov. 13, 2003, entitled “A Chucking System for Modulating Shapes of Substrates,” which is assigned to the assignee of the present invention and is incorporated by reference in its entirety herein.

Backing plate 26 is formed from a material that is substantially transparent to actinic radiation, e.g., ultraviolet (UV) radiation. In a further embodiment, backing plate 26 is formed from a material that is also substantially transparent to infrared (IR) radiation. To that end, backing plate 26 may be formed from such materials including, but not limited to, quartz, fused silica, and soda lime glass. Backing plate 26 may be coated with a coupling agent 35, wherein coupling agent 35 is substantially transparent to actinic radiation, e.g., UV radiation. In a further embodiment, coupling agent 35 is also substantially transparent to IR radiation. Coupling agent 35 may be deposited upon backing plate 26 in a plurality of methods including, but not limited to, spin coating and dip coating. Coupling agent 35 may be thermally treated, with such thermal treatment techniques including baking coupling agent 35 at a temperature in the range of 50° C.-150° C. for approximately fifteen minutes. Coupling agent 35 is employed to chemically bond to a layer in contact therewith when exposed to actinic radiation, e.g., UV radiation, described further below. An exemplary embodiment of coupling agent 35 used in the present invention is 3-(trimethoxysilyl)propyl acrylate available from Sigma-Aldrich located in St. Louis, Mo.

Mold 28 may be formed from any suitable material including materials that are substantially opaque to actinic radiation. Additionally, mold 28 may be formed from materials including, but not limited to, silicon, gallium arsenide, quartz, fused-silica, sapphire, organic polymers, siloxane polymers, borosilicate glass, fluorocarbon polymers or a combination thereof. In an exemplary case, mold 28 is formed from silicon. Mold 28 may be treated with a release layer 36. Release layer 36 may be formed from materials including, but not limited to, perfluoro silane, diamond-like carbon (DLC), diamond-like nano-composite or a surfactant. An example of a surfactant is disclosed in U.S. patent application Ser. No. 10/463,396, filed Jun. 17, 2003, entitled “Method to Reduce Adhesions Between a Conformable Region and Pattern of a Mold,” which is assigned to the assignee of the present invention and is incorporated by reference in its entirety herein. Release layer 36 may be deposited upon mold 28 before or after mold 28 is coupled to substrate 30 to form master template 24 and may be applied using any known method, with such methods including, but not limited to, chemical vapor deposition, physical vapor deposition, atomic layer deposition or various other techniques, such as dip coating and spin coating and the like.

Referring to FIGS. 2 and 3, mold 28 comprises a relief pattern 38 defined thereon. In an exemplary embodiment of the present invention, relief pattern 38 comprises a plurality of spaced-apart protrusions 40 and recessions 42, however, any relief pattern may be employed. The plurality of protrusions 40 and recessions 42 defines an original pattern that forms the basis of a pattern to be transferred onto backing plate 26, described more fully below. Protrusions 40 and recessions 42 have a height ‘h₁’ associated therewith, as shown in FIG. 3.

As mentioned above, in an example, mold 28 is formed from silicon. As a result, protrusions 40 and recessions 42 may comprise deep feature depths since anisotropic etching of deep features within silicon is well known. In the present invention, to form such deep feature depths of protrusions 40 and recessions 42, mold 28 is subjected to a lattice etch. The lattice etch provides a uniform etch of the silicon contained within mold 28 with an etch rate of 3-45 μm/hr. In the present invention, height ‘h₁’ of protrusions 40 and recessions 42 may have a value in the range of 5 μm-100 μm; however, smaller values of ‘h₁’ may be achieved if desired. In a preferred embodiment, height ‘h₁’ had a value of 60 μm.

By employing mold 28 having deep features of protrusions 40 and recessions 42, mold 28 may be used to form deep featured structures therefrom, with such structures having a pattern complimentary to relief pattern 38. The structure formed from mold 28 may then be utilized as a template in subsequent imprint lithography processes, and more specifically, in subsequent patterning of substrates. An exemplary imprint lithography method and system for patterning of substrates is described in U.S. patent application Ser. No. 10/194,410 filed July 2002 entitled “Method and System for Imprint Lithography using an Electric Field,” which is assigned to the assignee of the present invention and is incorporated by reference in its entirety herein.

Referring to FIG. 4, a flowable region, such as an imprinting layer 44, is disposed on a surface 46 of mold 28. Imprinting layer 44 may be deposited upon mold 28 in a plurality of methods including, but not limited to, spin coating techniques and discrete fluid dispense techniques. In an exemplary technique of the present invention, imprinting layer 44 is deposited upon mold 28 as a plurality of spaced-apart discrete droplets 48. In a further embodiment, imprinting layer 44 may be deposited upon backing plate 26 in a plurality of methods including, but not limited to, spin coating techniques, discrete fluid dispense techniques, and as a plurality of spaced-apart droplets. In a further embodiment, imprinting layer 44 may be substantially transparent to actinic radiation. Imprinting layer 44 may comprise a composition selected from, but not limited to, polycarbonate, poly(methylmethacrylate), epoxy, a sol-gel material, and a hybrid sol-gel material. In an example of the present invention, imprinting layer 44 comprises a hybrid sol-gel material, wherein the sol-gel material has both an organic and inorganic composition. An exemplary hybrid sol-gel material used in the present invention is sold under the trade name Ormocer® B59 available from Microresist Technology GmbH located in Berlin, Germany.

The hybrid sol-gel material of the present invention comprises both inorganic and organic reactive functionality. During exposure of the hybrid sol-gel material to actinic radiation, e.g. UV radiation, described further below, a photoinitiator incorporated into the hybrid sol-gel initiates polymerization of organic functionality causing the hybrid material to solidify. Suitable photoinitiators for such a hybrid sol-gel depend on the reactive organic functionality used include, but not limited to, 1-hydroxycyclohexyl phenyl ketone, 2-chlorothioxanthone, 2-methylthioxanthone, and 2-isopropylthioxanthoney, where the reactive organic functionality is acrylic-ester based, or where the reactive organic functionality is epoxy or vinyl ether based.

The hybrid sol-gel as described above further contains an inorganic reactive functionality. Following exposure of the hybrid sol-gel material to actinic radiation, e.g. UV radiation, a thermal processing step allows the reactive inorganic functionality to crosslink to form a rigid, glass-like structured material through condensation polymerization, described further below. Such reactions are well known in the art to be possible with such materials including, but not limited to, silicon alkoxides, titanium alkoxides and aluminum alkoxides. Such reactions are enhanced by the presence of an acid. The acid may be, if desired, generated in such materials either during the application of actinic radiation, e.g. UV radiation, by the addition of photo-acid generators of the kind described above, or during the thermal process, described further below, by the use of thermal acid generators.

The hybrid sol-gel material employed in imprinting layer 44 has many properties associated therewith, with such properties offering advantages employed in the present invention. More specifically, the hybrid sol-gel material has properties, such as that a hard transparent pattern having desired deep features may be produced therefrom without the need to be subjected to high temperature settings. Thus, the hybrid sol-gel material may be formed using prior art techniques comparable to those utilized in connection with forming photresists, and, as a result, mass production of templates comprising the hybrid sol-gel material may be possible, described further below.

Additionally, the hybrid sol-gel material comprises other such properties to enable a coupling of imprinting layer 44 to backing plate 26. More specifically, the hybrid sol-gel material comprises a component that is responsive to actinic radiation, e.g., UV radiation, and cross-links in response thereto, forming a chemical bond between the hybrid sol-gel material of imprinting layer 44 and coupling agent 35 disposed on backing plate 26, described further below.

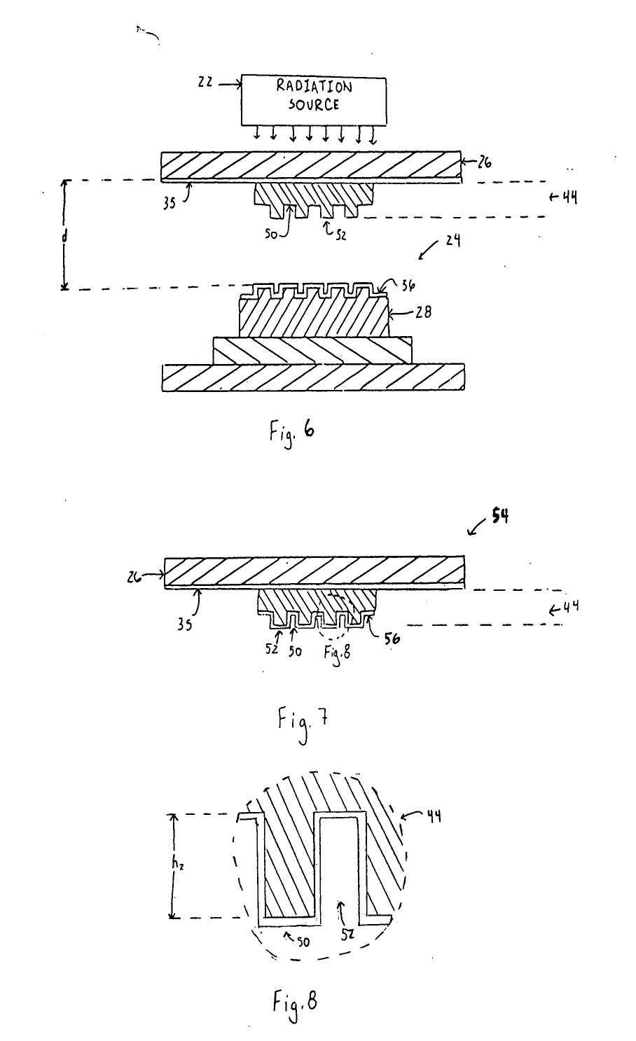

Referring to FIGS. 1 and 5, backing plate 26 is shown being coupled to motion stage 20. To that end, imprint head 18 and/or motion stage 20 may reduce distance “d” between master template 24 and backing plate 26 to allow droplets 48 to come into mechanical contact with coupling layer 35 of backing plate 26, spreading droplets 48 so as to form imprinting layer 44 with a contiguous formation over relief structure 38, with imprinting layer 44 substantially taking the shape of relief structure 38 and forming a pattern complimentary therefrom. Protrusions 40 of mold 28 form recessions 50 within imprinting layer 44, and recessions 42 of mold 28 form protrusions 52 within imprinting layer 44, shown more clearly in FIG. 6. In this manner, the features of mold 28 may be transferred onto backing plate 26 through imprinting layer 44, wherein imprinting layer 44 becomes coupled to backing plate 26 through chemical bonding.

Before separation of imprinting layer 44 from mold 28, imprinting layer 44 is subjected to actinic radiation, e.g., UV radiation. The UV radiation induces a chemical reaction between imprinting layer 44 and coupling agent 35 of backing plate 26, such that the hybrid sol-gel material of imprinting layer 44 becomes chemically bonded to coupling agent 35 when imprinting layer 44 is in contact with coupling agent 35. Specifically, as mentioned above, the hybrid sol-gel material comprises a component that facilitates solidification of the hybrid sol-gel material in response to actinic radiation. As a result, the hybrid sol-gel material of imprinting layer 44 becomes chemically bonded to coupling agent 35 upon exposure to UV radiation.

Referring to FIG. 6, furthermore, as mentioned above, mold 28 is treated with a release layer 36, wherein release layer 36 has a desired surface energy to facilitate release of imprinting layer 44 from mold 28 so as to minimize shearing or tearing of imprinting layer 44. In this fashion, the integrity of the desired pattern formed in imprinting layer 44 is maintained when imprinting layer 44 is separated from mold 28.

Referring to FIGS. 6 and 7, after impinging UV radiation upon imprinting layer 44, imprint head 18, shown in FIG. 1, is moved to increase the distance “d” so that master template 24 and backing plate 26 are spaced-apart. As mentioned above, imprinting layer 44 becomes chemically bonded to coupling agent 35 of backing plate 26. To that end, increasing the distance ‘d’ between master template 24 and backing plate 26 forms a daughter template 54, shown in FIG. 7. Daughter template 54 may subsequently be utilized in imprint lithography processes for patterning of substrates, as described above in the micro-fabrication of Willson et al. Daughter template 54 may be substantially transparent to UV radiation.

Referring to FIG. 8, as mentioned above, protrusions 40 of mold 28 form recessions 52 of imprinting layer 44 and recessions 42 of mold 28 form protrusions 50 of imprinting layer 44. To that end, protrusions 50 and recessions 52 of imprinting layer 44 have a height ‘h₂’ associated therewith. Height ‘h₂’ of imprinting layer 44 is substantially the same as height ‘h₁’ of mold 28. As a result, height ‘h₂’ of recessions 50 and protrusions 52 may have a value in the range of 10 μm-100 μm; however, smaller values of ‘h₂’ may be achieved if desired. In a preferred embodiment, height ‘h₂’ had a value of approximately 60 μm.

Referring to FIGS. 6 and 7, after the separation of imprinting layer 44 from mold 28 to form daughter template 54, daughter template 54 is thermally treating to complete the vitrification of the hybrid sol-gel material within imprinting layer 44. Furthermore, thermally treating the hybrid sol-gel material within imprinting layer 44 creates a condensation reaction within the hybrid sol-gel material to form a vitrified, glassy material. To that end, such thermal treatment methods include impinging IR radiation that is produced by radiation source 22 upon imprinting layer 44. The IR radiation produced by radiation source 22 may be transmitted through backing plate 26 and coupling layer 35. In a further embodiment, the IR radiation produced by radiation source 22 may be impinged directly onto imprinting layer 44 without being transmitted through backing plate 26 and coupling layer 35. In a further embodiment, microwave radiation may be impinged upon imprinting layer 44. Other such thermal treatment methods include baking daughter template 54 at a temperature of 150° C. for approximately one to three hours.

In a further embodiment, a low surface energy layer 56 may be disposed upon imprinting layer 44. Low surface energy layer 56 has a desired surface energy associated therewith, wherein the desired surface energy minimizes adhesion between daughter template 54 and any substrates in contact therewith. Low surface energy layer 56 may be formed from materials including, but not limited to, a perfluoro silane, diamond-like carbon (DLC), diamond-like nano-composite, or a surfactant containing material. An exemplary low surface energy layer is disclosed in U.S. patent application Ser. No. 10/687,519, filed Oct. 16, 2003, entitled “Low Surface Energy Templates,” which is assigned to the assignee of the present invention and is incorporated by reference in its entirety herein.

The embodiments of the present invention described above are exemplary. For example, anomalies in processing regions other than film thickness may be determined. As a result, many changes and modifications may be made to the disclosure recited above, while remaining within the scope of the invention. Therefore, the scope of the invention should not be limited by the above description, but instead should be determined with reference to the appended claims along with their full scope of equivalents.

1. A method of forming a pattern on a plate employing a mold, said method comprising:
placing said plate in superimposition with said mold;
positioning formable material between said plate and said mold;
forming said pattern in said formable material to have a shape complementary to said mold, defining patterned material; and
adhering said patterned material to said plate.

2. The method as recited in claim 1 wherein positioning said formable material further includes depositing said formable material onto said mold.

3. The method as recited in claim 1 wherein positioning said formable material further includes depositing said formable material on said mold as a plurality of spaced-apart droplets.

4. The method as recited in claim 1 wherein positioning said formable material further includes depositing said formable material onto said mold, with forming further including contacting said formable material with said plate.

5. The method as recited in claim 1 wherein positioning said formable material further includes depositing said formable material onto said mold, with forming further including contacting said formable material with said plate and impinging radiation upon said patterned material to solidify said patterned material.

6. The method as recited in claim 1 further including depositing a coupling agent on a surface of said plate, with adhering said patterned material to said plate further including forming a chemical bond between said patterned material and said coupling agent.

7. The method as recited in claim 1 further including forming said plate to be substantially transparent to actinic radiation.

8. The method as recited in claim 1 further includes providing said formable material from a group of materials consisting of sol-gel, hybrid sol-gel, polycarbonate, polymethylmethacrylate, and epoxy.

9. The method as recited in claim 1 further including providing said mold with features having a height greater than 10 μm.

10. The method as recited in claim 1 further including providing said mold with features having a height in a range of 10 μm to 100 μm.

11. The method as recited in claim 1 further including forming said mold from a group of materials consisting of silicon, gallium arsenide, quartz, fused-silica, sapphire, organic polymers, siloxane polymers, borosilicate glass, fluorocarbon polymers and a combination thereof.

12. The method as recited in claim 1 further including forming said plate from a group of materials consisting of quartz, fused silica, and soda lime glass.

13. The method as recited in claim 1 wherein positioning said formable material further includes depositing said formable material on said plate as a plurality of spaced-apart droplets.

14. A method of forming a pattern on a plate employing a mold, said method comprising:
placing said plate in superimposition with said mold;
positioning formable material between said plate and said mold;
forming said pattern in said formable material to have a shape complementary to said mold by exposing said formable material to actinic radiation defining cross-linked material; and
condensing said cross-linked material by thermally treating said cross-linked material, defining patterned material.

15. The method as recited in claim 14 further including adhering said patterned material to said plate.

16. The method as recited in claim 15 further including depositing a coupling agent on a surface of said plate, with adhering said patterned material to said plate further including forming a chemical bond between said patterned material and said coupling agent.

17. The method as recited in claim 14 wherein positioning further includes depositing said formable material as a plurality of droplets on said mold.

18. The method as recited in claim 14 further including providing said mold with features having height greater than 10 μm.

19. The method as recited in claim 14 further including providing said mold with features having a height in a range of 10 μm to 100 μm.

20. The method as recited in claim 14 wherein said formable material is selected from a group consisting of sol-gel, hybrid sol-gel, polycarbonate, polymethylmethacrylate, and epoxy.

21. The method as recited in claim 14 wherein said mold is selected from a group consisting of silicon, quartz, fused-silica, sapphire, organic polymers, siloxane polymers, borosilicate glass, fluorocarbon polymers or a combination thereof.

22. The method as recited in claim 14 wherein positioning said formable material further includes depositing said formable material on said plate as a plurality of spaced-apart droplets.

23. A method of forming a pattern on a plate employing a mold, said method comprising:
placing said plate in superimposition with said mold, with said plate having a coupling agent disposed on a surface thereof;
depositing formable material on said mold as a plurality of spaced-apart droplets;
contacting said formable material with said plate to form said pattern in said formable material to have a shape complementary to said mold, defining patterned material; and
impinging actinic radiation upon said patterned material to couple said patterned material to said coupling agent of said plate.

24. The method as recited in claim 23 wherein impinging actinic radiation further includes solidifying said patterned material.

25. The method as recited in claim 24 wherein impinging actinic radiation further includes forming a chemical bond between said patterned material and said coupling agent.

26. The method as recited in claim 25 further including providing said mold with features having dimensions greater than 10 μm.

27. The method as recited in claim 26 further including providing said mold with features having a height in a range of 10 μm to 100 μm.

28. The method as recited in claim 27 further including forming said plate to be substantially transparent to actinic radiation.

29. The method as recited in claim 28 further includes providing said formable material from a group of materials consisting of sol-gel, hybrid sol-gel, polycarbonate, polymethylmethacrylate, and epoxy.

30. The method as recited in claim 29 further including forming said mold from an additional group of materials consisting of silicon, gallium arsenide, quartz, fused-silica,.sapphire, organic polymers, siloxane polymers, borosilicate glass, fluorocarbon polymers and a combination thereof.

31. The method as recited in claim 30 further including forming said plate from a further group of materials consisting of quartz, fused silica, and soda lime glass.
